(19) United States
(12) Patent Application Publication
(10) Pub. No.: US 2008/0073325 A1
(43) Pub. Date: Mar. 27, 2008

(54) Mirror etching solution

(76) Inventor: Timothy Ray Poe, Birmingham, AL (US)

Correspondence Address: BAKER, DONELSON, BEARMAN, CALDWELL & BERKOWITZ, SIX CONCOURSE PARKWAY, SUITE 3100, ATLANTA, GA, 30328, US

(21) Appl. No.: 11/973,416

(22) Filed: Oct. 9, 2007

Related U.S. Application Data
(62) Division of application No. 10/711,183, filed on Aug. 31, 2004, now abandoned.

(51) Int. Cl. B44C 1/22

(52) U.S. Cl. 216/97

(57) ABSTRACT

A mirror etching solution is a solution of water and sulfated potash and when applied to the electroplated surface on the back, or non-reflective surface, of a mirror, effectively simulates the appearance of a tarnished or deteriorated “antique” mirror. The electroplated surface applied to the back of new mirrors is normally sealed with a painted protective coating. In order to etch the electroplated surface on new mirrors, the painted protective coating must be stripped with paint and varnish remover to expose the electroplated surface. After this mirror etching solution is applied to the electroplated surface and the desired effect has been achieved, the electroplated surface on the back of the mirror may be sealed with a new painted protective coating. New mirrors that have been electroplated and not yet sealed with a painted protective coating may be treated with this mirror etching solution before sealing.

This application is a division of U.S. patent application Ser. No. 10/711,183, filed Aug. 31, 2004.

A mirror etching solution is a solution of water and sulfated potash.

When applied to the electroplated surface on the back, or non-reflective surface of a mirror, the solution will effectively simulate the appearance of a tarnished or deteriorated “antique” mirror when viewed from the front of the mirror, the reflective mirror surface.

A mirror etching solution will tarnish and or deteriorate the electroplated surface on the back, or non-reflective surface of a mirror, effectively simulating the appearance of a tarnished or deteriorated “antique” mirror when viewed from the front of the mirror, the reflective mirror surface.

The effects or degree of tarnish and deterioration on the electroplated surface may be controlled by adjusting the ratio of the solution, the temperature of the solution and or the method of application of the solution.

A ratio of one teaspoon by volume of sulfated potash to one gallon of water where the solution is at room temperature and applied onto the electroplated surface on the back of a mirror will produce only a light tarnished or dulled effect when viewed from the front of the mirror, the reflective mirror surface.

A ratio of one tablespoon by volume of sulfated potash to one gallon of water where the solution is at room temperature and applied onto the electroplated surface on the back of a mirror will produce a light charcoal gray tarnished and or distressed effect when viewed from the front of the mirror, the reflective mirror surface.

A ratio of one tablespoon by volume of sulfated potash to one gallon of water heated to 140 degrees Fahrenheit and applied to the electroplated surface on the back of a mirror will produce a dark charcoal gray tarnished and or heavy distressed effect when viewed from the front of the mirror, the reflective mirror surface.

The method of application of the solution will also affect the appearance of the reflective mirror surface. There are various methods of application of the solution. Four basic methods of application are spraying, pouring, dipping and or brushing the solution onto the electroplated surface on the back of a mirror.

After the desired “antique” mirror effect is achieved and the surface of the etched electroplated surface on the back of the mirror is dry, the etched electroplated surface may be sealed with a painted protective coating.

This invention has been described in detail with particular reference to certain embodiments, but variations and modifications can be made without departing from the spirit and scope of the invention as defined in the following claims.

What is claimed is:

1. A method for tarnishing an electroplated non-reflective surface of a mirror, wherein the method comprises applying to the electroplated non-reflective surface a composition which comprises sulfated potash and water.

2. A method as defined by claim 1 wherein the composition is applied to the electroplated non-reflective surface by spraying, pouring, dipping or brushing.

3. A method as defined by claim 1 wherein the composition comprises sulfated potash and water in a ratio of one teaspoon of sulfated potash, by volume, to one gallon of water.

4. A method as defined by claim 1 wherein the composition comprises sulfated potash and water in a ratio of one tablespoon of sulfated potash, by volume, to one gallon of water.
